(19) United States
(12) Patent Application Publication
(10) Pub. No.: US 2007/0044898 A1
(43) Pub. Date: Mar. 1, 2007

(54) Apparatus and method for matching and splicing webs

(75) Inventors: Shinji Hikita, Minami-Ashigara-shi (JP); Koji Tonohara, Minami-Ashigara-shi (JP); Minoru Takahashi, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/513,043

(22) Filed: Aug. 31, 2006

(30) Foreign Application Priority Data
Aug. 31, 2005 (JP) 2005-252051

(51) Int. Cl. B65H 19/18; B31F 5/00; G03D 15/04

(52) U.S. Cl. 156/159; 156/157; 156/502; 156/504; 156/505

(57) ABSTRACT

A method for matching and splicing webs that splices, by use of splicing tape, a rear end of a strip-shaped flexible backing that is drawn and conveyed from an old roll and a front end of a strip-shaped flexible backing that is drawn and conveyed from a new roll, in a state in which the front end and the rear end are matched, wherein the method performs matching and splicing by executing: a preparation step of performing matching and splicing preparations by retaining a front end of a strip-shaped flexible backing of the new roll with one of a pair of cutting drums, and supplying splicing tape to a pair of splicing drums, respectively; a cutting step of cutting with the pair of cutting drums a strip-shaped flexible backing of the old roll and a strip-shaped flexible backing of the new roll in an overlapping state after the preparation step; a feeding step of feeding to a splicing position a rear end of the strip-shaped flexible backing of the old roll and a front end of the strip-shaped flexible backing of the new roll that are cut in the cutting step, as they are in a matched state; and a splicing step of using the pair of splicing drums to adhere and attach splicing tape to each of a front surface side and a rear surface side of a matching portion that is fed to a splicing position in the feeding step; wherein, in the preparation step, at least one of the pair of splicing drums is driven independently, and in the cutting step, the feeding step and the splicing step, the one of the pair of splicing drums is driven in synchrony with other drums.

### BACKGROUND OF THE INVENTION

1. Field of the Invention

The present invention relates to an apparatus and method for matching and splicing webs, and more particularly to an apparatus and method for matching and splicing webs that splices the ends of strip-shaped flexible backings (hereunder, referred to as “webs”) such as plastic, paper, or metallic foil.

2. Description of the Related Art

As disclosed in Japanese Examined Application Publication No. 49-12329, this type of apparatus for matching and splicing webs consists of a turret apparatus and a cutting and splicing unit for webs. The turret apparatus has a turret arm, and switches the positions of an old roll and a new roll that are pivotally supported at both ends of the turret arm to sequentially supply webs to the cutting and splicing unit. The cutting and splicing unit has a pair of cutting drums and a pair of splicing drums. It uses the cutting drums to cut the rear end of the web of the old roll that is being rewound and the front end of the web of the new roll for which rewinding is to be started while successively supplying the rolls, and after cutting it uses the splicing drums to splice the ends of the webs with splicing tape. According to this kind of splicing apparatus, it is possible to match and splice the ends of the web of the old roll and the web of the new roll while successively supplying the rolls.

However, in a case where an emulsion is coated on the surface of the webs there is a problem that even if splicing tape is adhered and attached to the front surface side of the webs the splicing tape is liable to become unstuck from the webs. Therefore, a method for adhering and attaching matching portions of webs with splicing tape from the rear surface side has been proposed (see Japanese Patent Application Laid-Open No. 50-84670). According to this method, splicing drums are disposed on both the front surface side and the rear surface side of webs, splicing tape is provided for each splicing drum, and the splicing tape is adhered to the matching portion of the webs by rotating these splicing drums in synchrony with the cutting drums.

### SUMMARY OF THE INVENTION

However, in the conventional splicing apparatus there is a problem that in order to rotate the drums in synchrony it is not possible to freely adjust the rotational position (posture) of each splicing drum, and therefore an operation to prepare splicing tape in each splicing drum is complicated. More specifically, although an operation to prepare splicing tape in the splicing drums is normally performed automatically by a tape supply apparatus, in a case where the drums are synchronized the rotational position of each splicing drum is already determined at the time of the preparation operation and therefore a case arises in which a tape supply apparatus can not be disposed, and there is thus a problem that the operator must supply splicing tape to the splicing drums manually.

This invention was made in view of the foregoing situation, and an object of this invention is to provide an apparatus and method for matching and splicing webs that easily performs a preparation operation for supplying splicing tape to a pair of splicing drums.

To attain the above object, a first aspect of the present invention provides a method for matching and splicing webs that splices, by use of splicing tape, a rear end of a strip-shaped flexible backing that is drawn and conveyed from an old roll and a front end of a strip-shaped flexible backing that is drawn and conveyed from a new roll, in a state in which the front end and the rear end are matched, wherein the method performs matching and splicing by executing: a preparation step of performing matching and splicing preparations by retaining a front end of a strip-shaped flexible backing of the new roll with one of a pair of cutting drums, and supplying splicing tape to a pair of splicing drums, respectively; a cutting step of cutting with the pair of cutting drums a strip-shaped flexible backing of the old roll and a strip-shaped flexible backing of the new roll in an overlapping state after the preparation step; a feeding step of feeding to a splicing position a rear end of the strip-shaped flexible backing of the old roll and a front end of the strip-shaped flexible backing of the new roll that are cut in the cutting step, as they are in a matched state; and a splicing step of using the pair of splicing drums to adhere and attach splicing tape to each of a front surface side and a rear surface side of a matching portion that is fed to a splicing position in the feeding step; wherein, in the preparation step, at least one of the pair of splicing drums is driven independently, and in the cutting step, the feeding step and the splicing step, the one of the pair of splicing drums is driven in synchrony with other drums.

According to the invention set forth in the first aspect, since one of a pair of splicing drums is independently driven in the preparation step it is possible to supply splicing tape to that splicing drum from an arbitrary direction. Accordingly, an operation to prepare splicing tape on a splicing drum can be performed easily. Further, a splicing tape supply apparatus can be provided in an arbitrary direction of the splicing drum, and splicing tape can be automatically supplied.

A second aspect of the present invention is in accordance with the invention set forth in the first aspect, wherein the one splicing drum is connected via a clutch mechanism to a main drive system that drives other drums, and the clutch mechanism switches between the independent driving and the synchronized driving.

According to the invention set forth in the second aspect, it is possible to switch between independent driving and synchronized driving for one of the splicing drums by use of a clutch mechanism.

A third aspect of the present invention is in accordance with the invention set forth in the first aspect, wherein the one splicing drum is driven by an independent drive system that is independent from a main drive system that drives other drums.

According to the invention set forth in the third aspect, since one splicing drum can be driven independently from other drums, a rotational position of the one splicing drum can be freely adjusted.

To attain the above described object, a fourth aspect of the present invention provides an apparatus for matching and splicing webs that splices, by use of splicing tape, a rear end of a strip-shaped flexible backing that is drawn and conveyed from an old roll and a front end of a strip-shaped flexible backing that is drawn and conveyed from a new roll, in a state in which the front end and the rear end are matched, comprising: a turret device that supports the old roll and the new roll in a drawnable condition and is rotatable at predetermined angles; a pair of cutting drums that cut a strip-shaped flexible backing of an old roll and a strip-shaped flexible backing of a new roll in an overlapping state by rotationally driving at the same speed as a conveying speed of the strip-shaped flexible backings at a time of a splicing operation; a pair of splicing drums that comprise a tape retaining part that retains the splicing tape and that, by rotationally driving at the same speed as a conveying speed of the strip-shaped flexible backings at a time of a splicing operation, adhere and attach the splicing tape from a front surface side and a rear surface side, respectively, to a matching portion of ends of the two strip-shaped flexible backings; a main drive system that synchronously drives other drums that exclude at least one splicing drum of the pair of splicing drums; and a switch drive device that drives the one splicing drum by switching between independent driving and synchronized driving with the main drive system.

According to the invention set forth in the fourth aspect, since one splicing drum is switched between independent driving and synchronized driving, it is possible to drive the one splicing drum in synchrony with other drums to perform matching and splicing of strip-shaped flexible backings, and also to independently drive the one splicing drum to adjust a rotational position thereof to supply a splicing tape from an arbitrary direction.

A fifth aspect of the present invention is in accordance with the invention set forth in claim 4, wherein the switch drive device comprises a clutch mechanism that engages with or disconnects from the main drive system.

According to the invention set forth in the fifth aspect, by employing a clutch mechanism to engage or disconnect one of the splicing drums with or from the main drive system, it is possible to switch between independent driving and synchronized driving.

A sixth aspect of the present invention is in accordance with the invention set forth in the fourth aspect, wherein the switch drive device comprises an independent drive system that drives the one splicing drum independently from the main drive system; and a control device that controls so as to synchronize the main drive system and the independent drive system.

According to the invention set forth in the sixth aspect, since one of the splicing drums can be driven independently from the other drums, the rotational position of the one splicing drum can be freely adjusted.

According to this invention, since one of a pair of splicing drums can be independently driven, supply of splicing tape to that one splicing drum can be performed from an arbitrary direction and thus an operation to prepare splicing tape can be carried out easily.

### BRIEF DESCRIPTION OF THE DRAWINGS

FIG. 1 is an overall configuration diagram of an apparatus for matching and splicing webs according to an embodiment of this invention;

FIG. 2 is a configuration diagram of a cutting and splicing unit for explaining a splicing operation;

FIG. 3 is a configuration diagram of a cutting and splicing unit for explaining a splicing operation;

FIG. 4 is a configuration diagram of a cutting and splicing unit for explaining a splicing operation;

FIG. 5 is a configuration diagram of a cutting and splicing unit for explaining a splicing operation;

FIG. 6 is a configuration diagram of a cutting and splicing unit for explaining a splicing operation;

FIG. 7 is a configuration diagram of a cutting and splicing unit for explaining a splicing operation;

FIG. 8 is a configuration diagram of a cutting and splicing unit for explaining a splicing operation;

FIG. 9 is a configuration diagram of a cutting and splicing unit for explaining a splicing operation;

FIG. 10 is a schematic diagram that illustrates a drum drive system;

FIG. 11 is a schematic diagram that illustrates the configuration of a tape supply apparatus; and

FIG. 12 is a schematic diagram that illustrates a drum drive system that is different to the system illustrated in FIG. 10.

### DETAILED DESCRIPTION OF THE PREFERRED EMBODIMENTS

Hereunder, preferred embodiments of the apparatus and method for matching and splicing webs according to this invention will be described in accordance with the attached drawings.

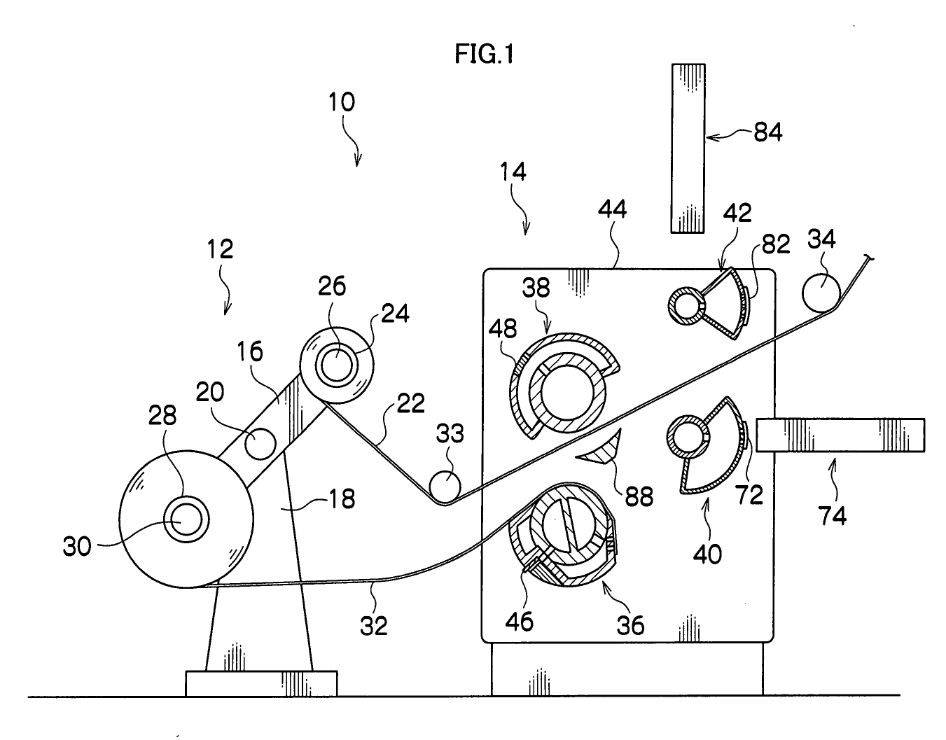

FIG. 1 is an overall configuration diagram of an apparatus for matching and splicing webs according to an embodiment of this invention. As shown in the figure, a splicing apparatus 10 mainly consists of a turret apparatus 12 and a cutting and splicing unit 14.

The turret apparatus 12 has a turret arm 16, and this turret arm 16 is provided in a rotatable condition on a columnar support 18 with a shaft 20 as a pivot. An old roll 24 for which rewinding of a web 22 is being completed is rotatably supported via a shaft 26 at one end of the turret arm 16, and a new roll 28 for which rewinding of a web 32 is to be started is rotatably supported via a shaft 30 at the other end of the turret arm 16. After being rewound from the old roll 24, the web 22 that is wound on the old roll 24 is transferred into contact with the guide roller 33 and guided to the cutting and splicing unit 14.

The cutting and splicing unit 14 comprises a cutting drum 36, a cutting and splicing drum (corresponds to cutting drum) 38, a front surface splicing drum 40, and a rear surface splicing drum 42. The respective drums 36, 38, 40 and 42 are provided in a machine casing 44.

The web 22 from the aforementioned old roll 24 is passed between the cutting drum 36 and cutting and splicing drum 38 and between the front surface splicing drum 40 and rear surface splicing drum 42. After being guided by the guide roller 34, the web 22 is fed to a shock absorber (not shown) that buffers fluctuations in the tensile force or speed of the web 22. In contrast, after the front end of the web 32 of the new roll 28 is conveyed as far as the position of the cutting and splicing unit 14, it is attached to the cutting drum 36 to await completion of the splicing preparations.

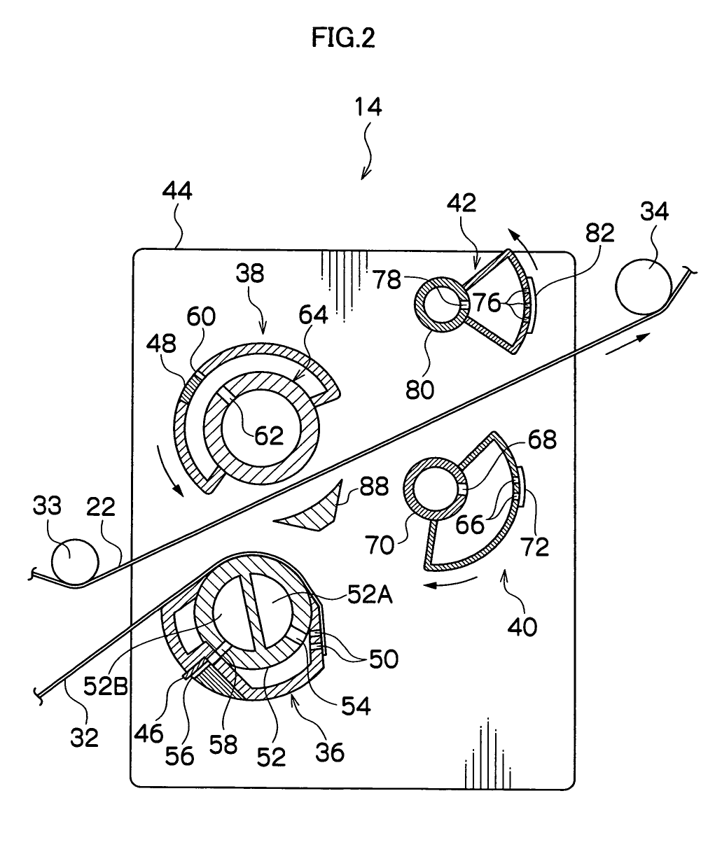

As shown in FIG. 2, a cutter 46 is provided at a peripheral portion of the cutting drum 36. The cutter 46 is attached in a state in which it protrudes by only a predetermined amount from the peripheral surface of the cutting drum 36. Further, to improve cutting sharpness, the cutter 46 is attached at a predetermined angle of inclination θ with respect to the width direction of the cutting drum 36 (i. e. the width direction of webs 22 and 32). A cutting portion 48 is provided in the cutting and splicing drum 38 at a position at which the cutter 46 contacts therewith, and the web 22 and the web 32 are cut with the cutting portion 48 and the cutter 46 by overlaying and inserting the web 22 and the web 32 at that position.

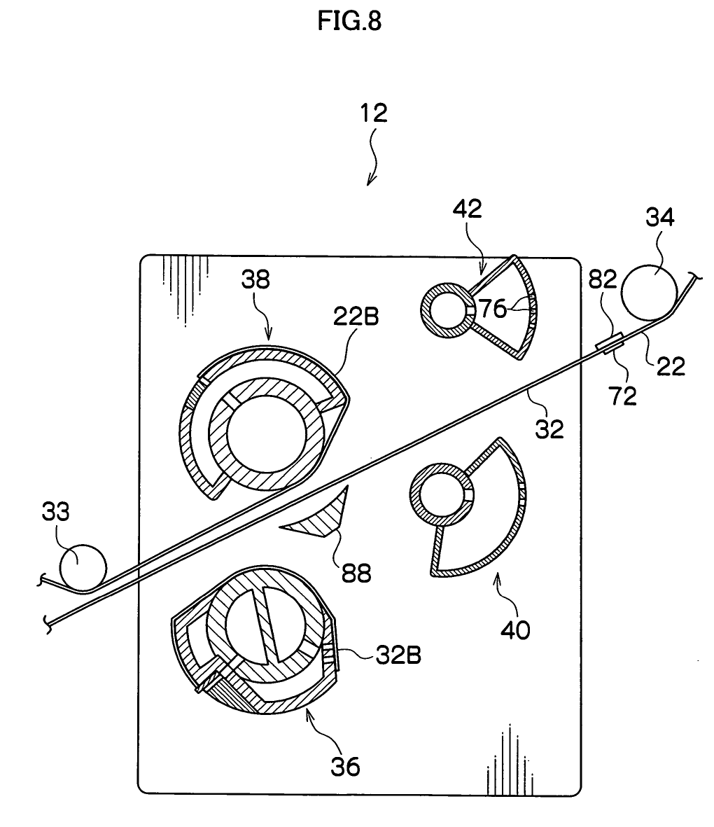

A flat portion is provided on the surface of the cutting drum 36, and air holes 50, 50 are formed in this flat portion. The air holes 50, 50 communicate with an internal space 52A of a rotating hollow shaft 52 via an air hole 54. The internal space 52A communicates with an unshown suction apparatus. By driving this suction apparatus a suction force acts through the air holes 50, 50 so that the vicinity of the front end of the web 32 is attached to and retained by the air holes 50, 50. At a peripheral portion of the cutting drum 36, an ejection hole 56 is formed at a position that is on the downstream side in the rotational direction with respect to the cutter 46. This ejection hole 56 communicates with an internal space 52B of the rotating hollow shaft 52 via an air hole 58. The internal space 52B communicates with an unshown air supply apparatus, and air is ejected from the ejection hole 56 by driving this air supply apparatus. It is therefore possible to separate from the cutting drum 36 a cutting remainder 32B (i. e. the end on the front end side of the web 32 after cutting; see FIG. 8) that remains after cutting the web 32.

The aforementioned cutting portion 48 is provided at a peripheral portion of the cutting and splicing drum 38, and a suction hole 60 is disposed on the downstream side in the rotational direction of the cutting portion 48. The suction hole 60 communicates with a rotating hollow shaft 64 via an air hole 62, and the rotating hollow shaft 64 is connected to an unshown suction apparatus. Accordingly, driving this suction apparatus causes a suction force to work through the suction hole 60, and a cutting remainder 22B (i. e. the end on the rear end side of the web 22 after cutting; see FIG. 8) to be described later can thus be attracted to and retained on the suction hole 60.

A plurality of air intake holes 66, 66 are formed at a peripheral portion of the front surface splicing drum 40. The air intake holes 66 communicate with a rotating hollow shaft 70 via an air hole 68, and the rotating hollow shaft 70 is connected to an unshown suction apparatus. Accordingly, by driving the suction apparatus a suction force works through the air intake holes 66, 66 such that a splicing tape 72 can be attracted to and retained at the air intake holes 66, 66. The splicing tape 72 is automatically supplied by a tape supply apparatus 74 shown in FIG. 1.

A plurality of air intake holes 76, 76 are formed at a peripheral portion of the rear surface splicing drum 42. The air intake holes 76 communicate with a rotating hollow shaft 80 via an air hole 78, and the rotating hollow shaft 80 is connected to an unshown suction apparatus. Accordingly, by driving the suction apparatus, a suction force works through the air intake holes 76, 76 such that a splicing tape 82 can be attracted to and retained at the air intake holes 76, 76. The splicing tape 82 is automatically supplied by a tape supply apparatus 84 shown in FIG. 1.

A guide member 88 is provided within the cutting and splicing unit 14. The guide member 88 guides the webs 22 and 32 to a splicing position after cutting. By means of the guide member 88, the rear end of the web 22 and the front end of the web 32 after cutting can be fed to the splicing position in a condition that maintains a state in which the two ends are matched. In this connection, an arc-shaped guide surface of the guide member 88 is coated with a fluorocarbon resin or the like so that there is little frictional resistance with respect to the webs 22 and 32.

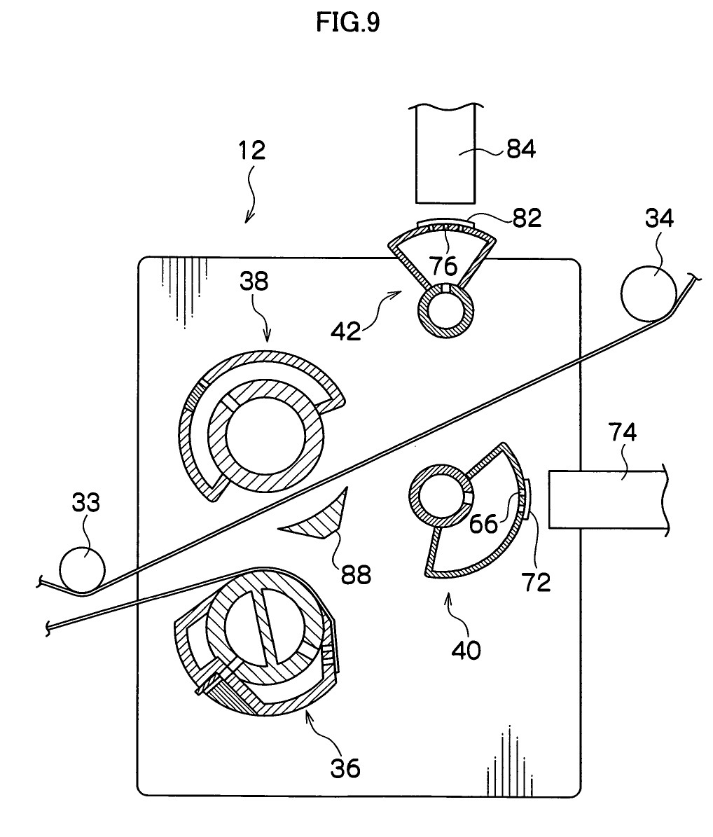

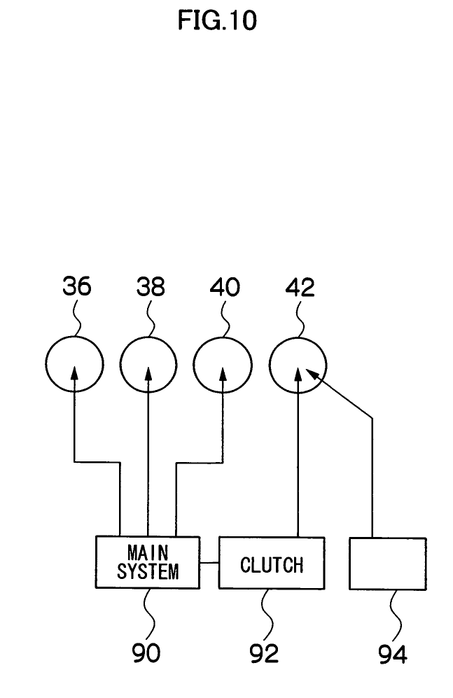

As shown in FIGS. 2 to 8, the above described cutting drum 36, cutting and splicing drum 38, front surface splicing drum 40, and rear surface splicing drum 42 can be rotationally driven in synchrony. Further, as shown in FIG. 9, the rear surface splicing drum 42 can be rotated independently from the other drums 36, 38 and 40. Hereunder, the drive system of each of the drums 36, 38, 40 and 42 is described based on FIG. 10.

As shown in FIG. 10, the cutting drum 36, the cutting and splicing drum 38 and the front surface splicing drum 40 are connected to a main drive system 90, and are rotationally driven in synchrony by the main drive system 90. The main drive system 90 is configured to rotationally drive the drums 36, 38 and 40 in synchrony by, for example, connecting a single motor to the drums 36, 38 and 40 via a timing belt or a gear.

In contrast, the rear surface splicing drum 42 is connected to the main drive system 90 via a clutch mechanism 92 that consists of an electromagnetic clutch or the like. Connecting and disconnecting of the power transmission path between the main drive system 90 and the rear surface splicing drum 42 is performed by the clutch mechanism 92. For example, a one position tooth clutch that engages at only one rotational position is used for the clutch mechanism 92. Use of this kind of clutch mechanism makes it is possible to connect the rear surface splicing drum 42 to the main drive system 90 for synchronized driving with the other drums 36, 38 and 40, or to disconnect the rear surface splicing drum 42 from the main drive system 90 to independently rotate the rear surface splicing drum 42. A driving apparatus 94 that can arbitrarily adjust the rotational position (posture) of the rear surface splicing drum 42 is connected thereto. By means of the driving apparatus 94, the posture of the rear surface splicing drum 42 can be adjusted between a standby position (see FIG. 2) and a tape preparation position (see FIG. 9) to be described later. Accordingly, it is possible to dispose the rear surface splicing drum 42 at the tape preparation position to perform a preparation operation by supplying the splicing tape 82 from the tape supply apparatus 84, and it is also possible to dispose the rear surface splicing drum 42 at the standby position to drive the rear surface splicing drum 42 in synchrony with the other drums 36, 38 and 40.

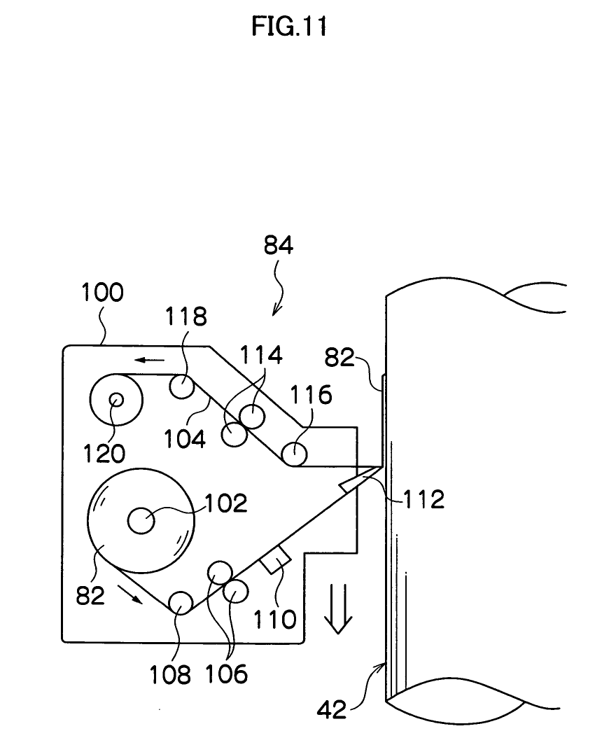

Next, the structure of the tape supply apparatus 84 will be described based on FIG. 11. In this connection, the tape supply apparatus 74 is configured in the same manner as the tape supply apparatus 84, and a description thereof is thus omitted here.

As shown in FIG. 11, the tape supply apparatus 84 has a reel 102 within a main body 100, and a lengthy splicing tape 82 is mounted in a wound state around the reel 102. The splicing tape 82 is wound in a state in which it is attached to a strippable paper carrier 104, and is fed forward from the reel 102 by rotationally driving feed rollers 106, 106. After passing a guide roller 108 and the feed rollers 106, 106, the splicing tape 82 that is fed forward from the reel 102 passes a cutter 110 to be fed to a stripping plate 112. The strippable paper carrier 104 is stripped off by the stripping plate 112 so that the splicing tape 82 is supplied to the surface of the rear surface splicing drum 42. After being stripped off, the strippable paper carrier 104 is fed forward by rotationally driving feed rollers 114, 114, and is guided by guide rollers 116 and 118 to be wound up by a reel 120.

The main body 100 of the tape supply apparatus 84 as described above is freely moveable in the axial direction of the rear surface splicing drum 42, and is moved by driving an unshown driving apparatus. As a result, the splicing tape 82 can be supplied in an axial direction of the rear surface splicing drum 42.

Next, a method for matching and splicing the webs 22 and 32 using the splicing apparatus 10 that is configured as described above will be explained on the basis of FIGS. 2 to 8.

First, as shown in FIG. 2, the apparatus is put in a standby state for a splicing operation. More specifically, operations are performed so that the front surface splicing drum 40 and the rear surface splicing drum 42 retain the splicing tapes 72 and 82, respectively, and the front end of the web 32 of the new roll 28 is held by the cutting drum 36. After the apparatus has entered the standby state, the clutch mechanism 92 shown in FIG. 10 is put in a state in which it connects the main drive system 90 and the rear surface splicing drum 42.

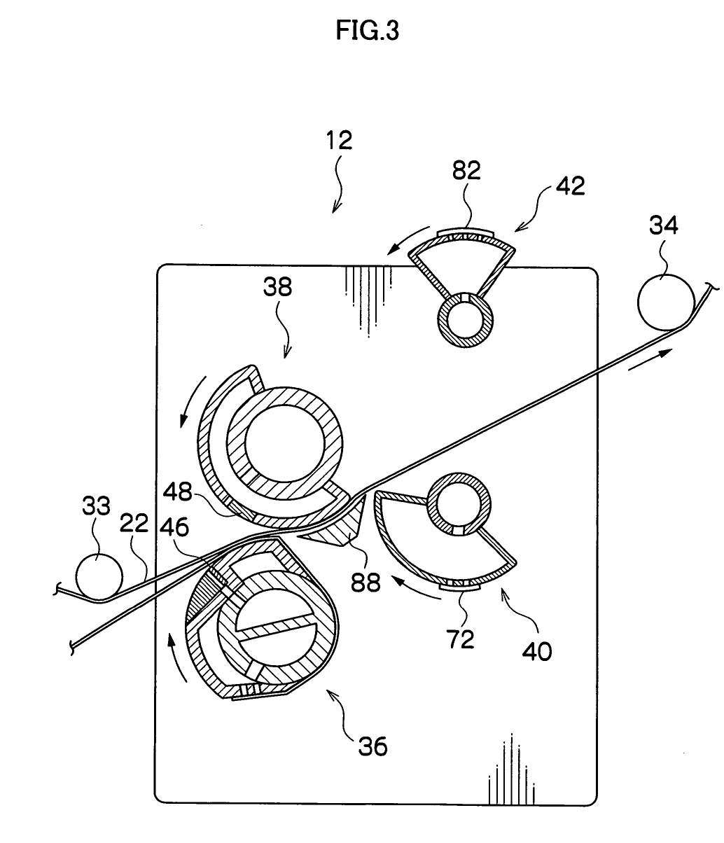

In this state, delivery of the web 22 from the old roll 24 is continued, and when the rear end of the web 22 appears, the main drive system 90 is driven to start rotation of the drums 36, 38, 40 and 42. By driving each of the drums 36, 38, 40 and 42 to perform one rotation in synchrony, matching and splicing is performed as shown in sequence in FIG. 3 to FIG. 8. Hereunder, the situation in each diagram will be described.

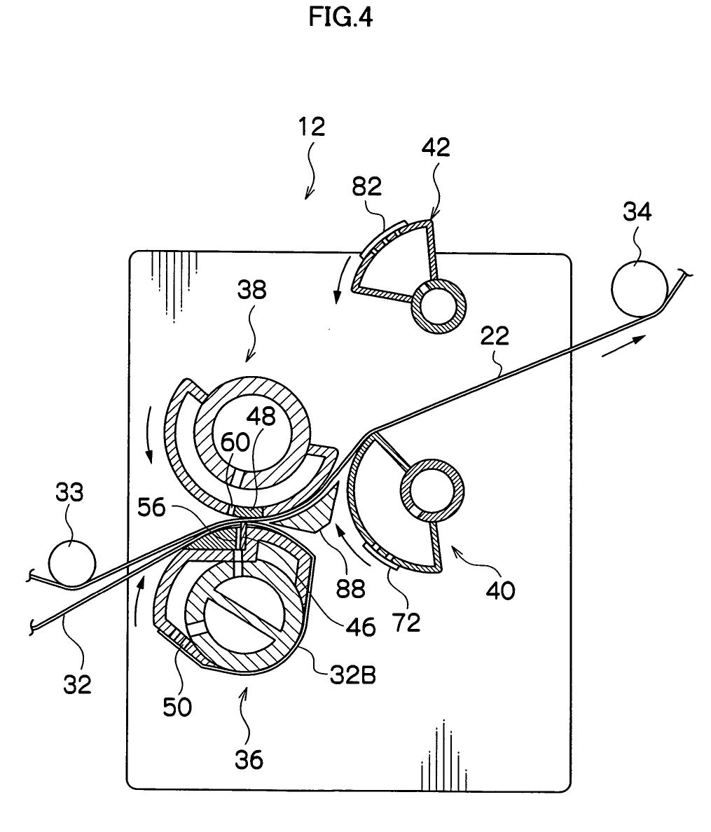

FIG. 3 shows a situation in which the webs 22 and 32 are first nipped by the cutting drum 36 and the cutting and splicing drum 38. By further rotating the cutting drum 36 and the cutting and splicing drum 38 from this situation, as shown in FIG. 4, the webs 22 and 32 are pinched and cut between the cutter 46 and the cutting portion 48 in an overlapping state. Thereby, a matching portion is formed in which the rear end of the web 22 and the front end of the web 32 after cutting are associated together.

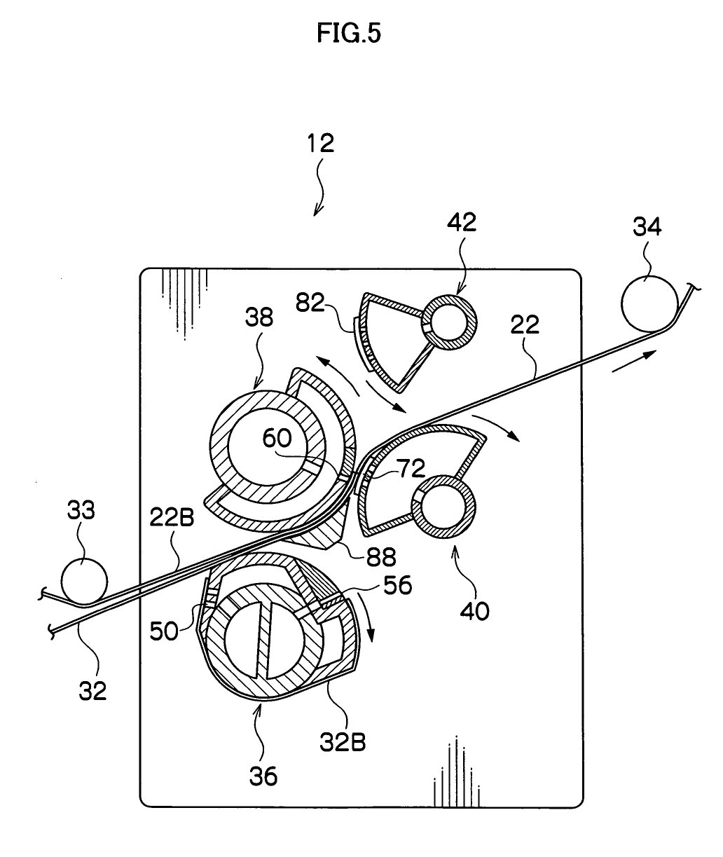

At the time of cutting as shown in FIG. 4, the web 22 is nipped by the cutting and splicing drum 38 and the front surface splicing drum 40, and by rotation of these drums 38 and 40 the matching portion is sent out from the cutting position. At this time, by ejection of air from the ejection hole 56 of the cutting drum 36 the matching portion is sent between the guide member 88 and the cutting and splicing drum 38. The matching portion is then fed to the splicing position shown in FIG. 5 by guidance of the guide member 88. During this time, the cutting remainder 32B that was generated on the front end side of the web 32 is held by suction on the air holes 50 of the cutting drum 36 and rotates together with the cutting drum 36, and as shown in FIG. 5, is removed from the conveying path of the webs 22 and 32.

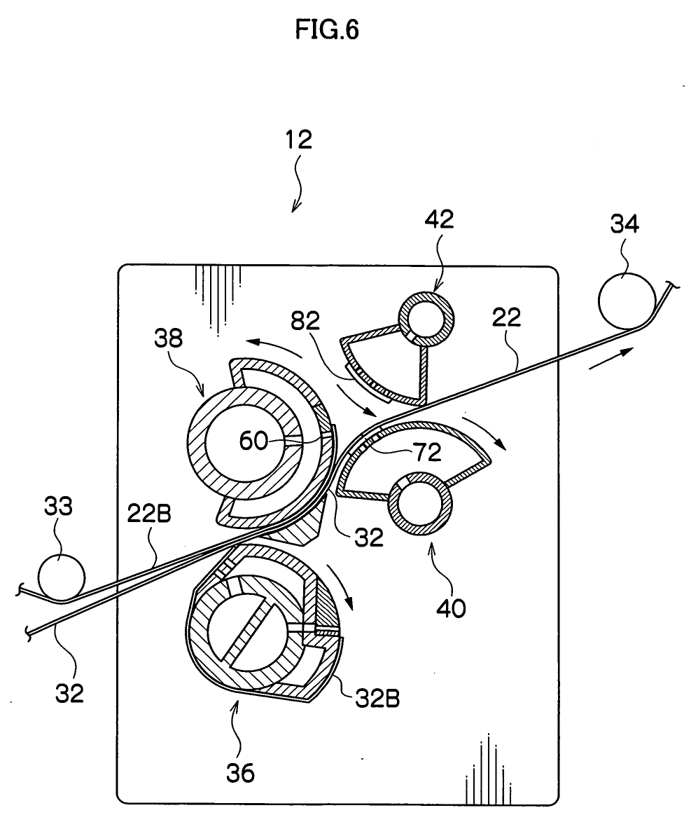

FIG. 5 shows a situation in which, while the matching portion of the webs 22 and 32 is nipped by the cutting and splicing drum 38 and the front surface splicing drum 40, the splicing tape 72 that is held on the splicing drum 40 is attached to the front surface side of the matching portion. Thus, the webs 22 and 32 are spliced in a state in which their respective ends are associated together. At this time, by performing suction from the suction hole 60 of the cutting and splicing drum 38, the cutting remainder 22B on the rear end side of the web 22 is retained by suction on the cutting and splicing drum 38. Accordingly, as shown in FIG. 6, the cutting remainder 22B is separated from the web 32 by rotation of the cutting and splicing drum 38.

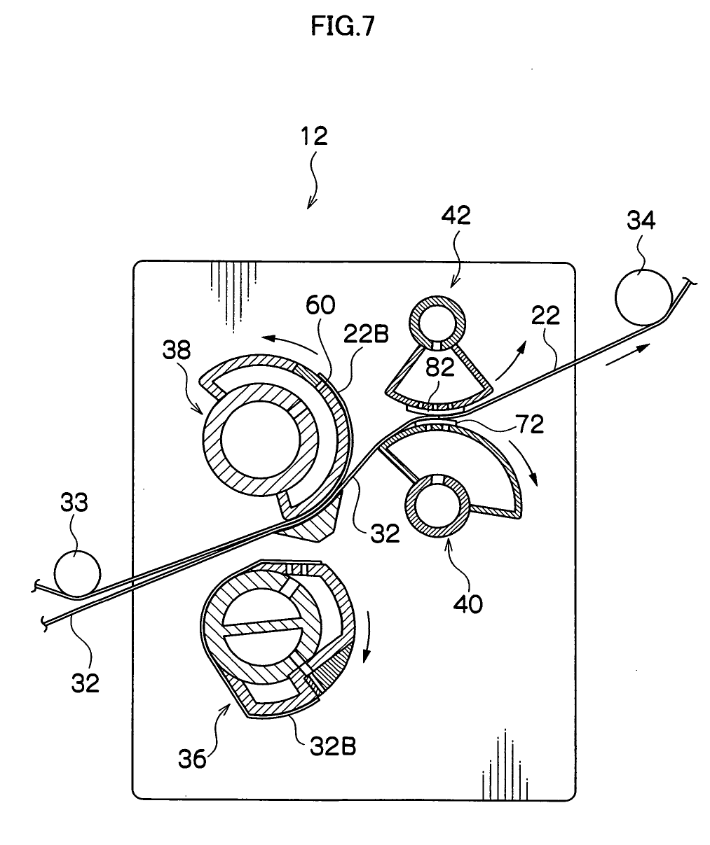

FIG. 6 shows a situation in which, while the web 32 is nipped by the front surface splicing drum 40 and the cutting and splicing drum 38, the web 22 has begun to be nipped by the front surface splicing drum 40 and the rear surface splicing drum 42. By further rotating the front surface splicing drum 40 and the rear surface splicing drum 42 from this situation, as shown in FIG. 7, the splicing tape 82 that was held on the rear surface splicing drum 42 is attached to the rear surface side of the matching portion. Thus, since the splicing tapes 72 and 82 are attached to the front surface side and rear surface side, respectively, of the matching portion of the webs 22 and 32, the webs 22 and 32 are matched and spliced in a firm manner.

After matching and splicing of the webs 22 and 32 ends, as shown in FIG. 8, each of the drums 36, 38, 40 and 42 returns to its original position (i. e. the standby position of FIG. 2) and stops. The cutting remainders 22B and 32B are then removed and a preparation operation is performed for the next splicing.

In the preparation operation, the front end of a new web is placed in a condition in which it is held by the cutting drum 36, and the splicing tapes 72 and 82 are supplied to and held by the front surface splicing drum 40 and the rear surface splicing drum 42, respectively. At that time, in the splicing completed state as shown in FIG. 8, the air intake holes 76 of the rear surface splicing drum 42 face the guide roller 34 side and it is thus not possible to supply and retain a new splicing tape 82.

Therefore, after releasing the connection between the main drive system 90 and the rear surface splicing drum 42 using the clutch mechanism 92 as shown in FIG. 10, the rear surface splicing drum 42 shown in FIG. 8 is rotated 90° in the anticlockwise direction by the driving apparatus 94 to thereby dispose the rear surface splicing drum 42 at the tape preparation position as shown in FIG. 9. In this tape preparation position the air intake holes 76 face upward, that is, the air intake holes 76 are in a state in which they face the direction of the tape supply apparatus 84, and it is thus possible to supply a new splicing tape 82 from the tape supply apparatus 84 and retain it on the rear surface splicing drum 42.

After retaining the splicing tape 82, the rear surface splicing drum 42 is rotated in the clockwise direction by the driving apparatus 94 so that it is moved to the standby position shown in FIG. 2. This standby position is a reference position for synchronizing the rear surface splicing drum 42 with the other drums 36, 38 and 40. Synchronized driving can be carried out by rotating the rear surface splicing drum 42 simultaneously with the other drums 36, 38 and 40 from this position, enabling precise performance of the above described splicing operation.

In this connection, in the front surface splicing drum 40, since the position of the air intake holes 66 faces the direction of the tape supply apparatus 74 in the splicing completed state as shown in FIG. 8, the splicing tape 72 can be supplied from the tape supply apparatus 74 in that state and retained thereon.

As described in the foregoing, according to the present embodiment, the rear surface splicing drum 42 and the main drive system 90 are connected through the clutch mechanism 92, and connecting and disconnecting of the rear surface splicing drum 42 and the main drive system 90 can be performed using the clutch mechanism 92. It is therefore possible to select between synchronized driving in which the rear surface splicing drum 42 is rotated in synchrony with the other drums 36, 38 and 40, and independent driving in which the rear surface splicing drum 42 is driven independently. Accordingly, by independently driving the rear surface splicing drum 42 at the time of a supply operation for supplying the splicing tape 82 to the rear surface splicing drum 42, the splicing tape 82 can be supplied from an arbitrary direction. Hence, it is possible to dispose the tape supply apparatus 84 in an arbitrary direction and to automatically supply the splicing tape 82.

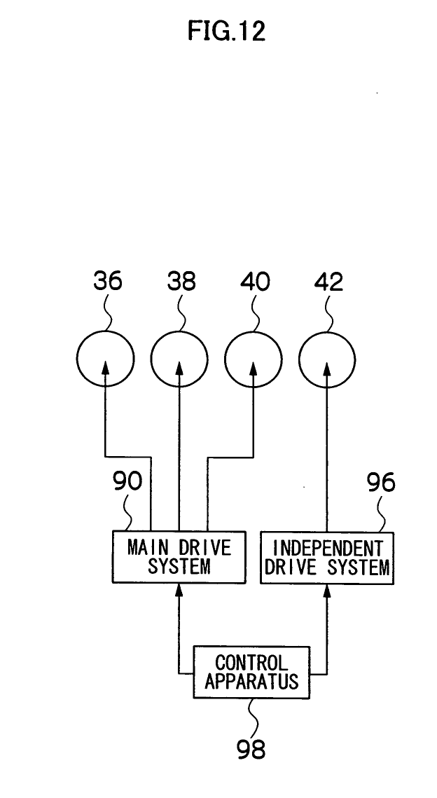

Although the above described embodiment was configured to connect the rear surface splicing drum 42 and the main drive system 90 via the clutch mechanism 92, and to switch between independent driving and synchronized driving of the rear surface splicing drum 42 by means of the clutch mechanism 92, the configuration of the drive mechanism is not limited thereto. For example, as shown in FIG. 12, a configuration may be adopted in which an independent drive system 96 is provided that rotates the rear surface splicing drum 42 independently from the main drive system 90, and the independent drive system 96 and the main drive system 90 are controlled by a control apparatus 98. The independent drive system 96 can set the rotational speed and rotational position of the rear surface splicing drum 42 independently and separately from the main drive system 90, and rotation of the rear surface splicing drum 42 can thus be started at a different timing to the other drums 36, 38 and 40, or can be slowed down at a different timing to the other drums 36, 38 and 40.

When configured as described above, after the rear surface splicing drum 42 is supplied with the splicing tape 82 in the tape preparation position, it stands by in that position. Then, after rotation of the other drums 36, 38 and 40 starts, rotation of the rear surface splicing drum 42 is controlled so that it starts to rotate a little later than the other drums so that it rotates in synchrony with the other drums 36, 38 and 40. As a result, the splicing operations as shown in FIG. 2 to FIG. 7 are performed. After the splicing operations, the rear surface splicing drum 42 is slowed down later than the other drums 36, 38 and 40 and stopped at the tape preparation position. Thus, the splicing tape 82 can be supplied to the rear surface splicing drum 42 by the tape supply apparatus 84. Further, by delaying the timing for decelerating the rear surface splicing drum 42, it is possible to prevent the rear surface splicing drum 42, which is the most liable to rub against the web 32, from rubbing against the web 32, to thereby control the generation of dust.

Although in the above described embodiment a configuration was adopted that can switch between independent driving and synchronized driving to drive the rear surface splicing drum 42, the present invention is not limited thereto, and a configuration may also be adopted in which the front surface splicing drum 40 is driven by switching between independent driving and synchronized driving.

What is claimed is:

1. A method for matching and splicing webs that splices, by use of splicing tape, a rear end of a strip-shaped flexible backing that is drawn and conveyed from an old roll and a front end of a strip-shaped flexible backing that is drawn and conveyed from a new roll, in a state in which the front end and the rear end are matched, wherein the method performs matching and splicing by executing:
a preparation step of performing matching and splicing preparations by retaining a front end of a strip-shaped flexible backing of the new roll with one of a pair of cutting drums, and supplying splicing tape to a pair of splicing drums, respectively;
a cutting step of cutting with the pair of cutting drums a strip-shaped flexible backing of the old roll and a strip-shaped flexible backing of the new roll in an overlapping state after the preparation step;
a feeding step of feeding to a splicing position a rear end of the strip-shaped flexible backing of the old roll and a front end of the strip-shaped flexible backing of the new roll that are cut in the cutting step, as they are in a matched state; and
a splicing step of using the pair of splicing drums to adhere and attach splicing tape to each of a front surface side and a rear surface side of a matching portion that is fed to a splicing position in the feeding step;
wherein, in the preparation step, at least one of the pair of splicing drums is driven independently, and in the cutting step, the feeding step and the splicing step, the one of the pair of splicing drums is driven in synchrony with other drums.

2. The method for matching and splicing webs according to claim 1, wherein the one splicing drum is connected via a clutch mechanism to a main drive system that drives other drums, and the clutch mechanism switches between the independent driving and the synchronized driving.

3. The method for matching and splicing webs according to claim 1, wherein the one splicing drum is driven by an independent drive system that is independent from a main drive system that drives other drums.

4. An apparatus for matching and splicing webs that splices, by use of splicing tape, a rear end of a strip-shaped flexible backing that is drawn and conveyed from an old roll and a front end of a strip-shaped flexible backing that is drawn and conveyed from a new roll, in a state in which the front end and the rear end are matched, comprising:
a turret device that supports the old roll and the new roll in a drawnable condition and is rotatable at predetermined angles;
a pair of cutting drums that cut a strip-shaped flexible backing of an old roll and a strip-shaped flexible backing of a new roll in an overlapping state by rotationally driving at the same speed as a conveying speed of the strip-shaped flexible backings at a time of a splicing operation;
a pair of splicing drums that comprise a tape retaining part that retains the splicing tape and that, by rotationally driving at the same speed as a conveying speed of the strip-shaped flexible backings at a time of a splicing operation, adhere and attach the splicing tape from a front surface side and a rear surface side, respectively, to a matching portion of ends of the two strip-shaped flexible backings;
a main drive system that synchronously drives other drums that exclude at least one splicing drum of the pair of splicing drums; and
a switch drive device that drives the one splicing drum by switching between independent driving and synchronized driving with the main drive system.

5. The apparatus for matching and splicing webs according to claim 4, wherein the switch drive device comprises a clutch mechanism that engages with or disconnects from the main drive system.

6. The apparatus for matching and splicing webs according to claim 4, wherein the switch drive device comprises:
an independent drive system that drives the one splicing drum independently from the main drive system; and
a control device that controls so as to synchronize the main drive system and the independent drive system.
